(19) United States
(12) Patent Application Publication
(10) Pub. No.: US 2023/0176872 A1
(43) Pub. Date: Jun. 8, 2023

(54) ARITHMETIC PROCESSING DEVICE AND ARITHMETIC PROCESSING METHOD

(71) Applicant: FUJITSU LIMITED, Kawasaki-shi (JP)

(72) Inventor: Katsuhiro Yoda, Kodaira (JP)

(73) Assignee: FUJITSU LIMITED, Kawasaki-shi (JP)

(21) Appl. No.: 17/953,373

(22) Filed: Sep. 27, 2022

(30) Foreign Application Priority Data
Dec. 2, 2021 (JP) 2021-196435

(51) Int. Cl. G06F 9/38; G06F 9/30

(52) U.S. Cl. CPC G06F 9/3887; G06F 9/3001

(57) ABSTRACT

An arithmetic processing device includes one or more lanes configured to execute at most a single element operation of an instruction for each cycle, and an element operation issuing processor configured to issue the element operations to the one or more lanes. Each lane is separated into a plurality of sections by a buffer that has a plurality of entries. While the one or more sections that are not able to continue processing of the element operations stop the processing, another section stores an element operation that proceeds to each downstream section in an immediately subsequent buffer and continues processing, and at a horizontal addition processing, a lane in which addition results are finally aggregated is set to be variable, and a target lane that waits for synchronization is set to be a lane adjacent to its own lane.

### CROSS-REFERENCE TO RELATED APPLICATION

This application is based upon and claims the benefit of priority of the prior Japanese Patent Application No. 2021-196435, filed on Dec. 2, 2021, the entire contents of which are incorporated herein by reference.

### FIELD

The embodiment discussed herein is related to an arithmetic processing device and an arithmetic processing method.

### BACKGROUND

In a high-performance computing field using supercomputers or the like, high-performance conjugate gradient (HPCG) has attracted attention as a benchmark used to measure performance closer to a real application.

Calculation of the HPCG is a solution of a linear simultaneous equation based on a multigrid preconditioned conjugate gradient method (MGCG), in which an inner product of a row of a sparse matrix A and a dense vector x occupies about 80% of the calculation. Because the HPCG is based on 27 point stencil, the number of nonzero elements in one row of the sparse matrix A is 27 that is very small. Therefore, the sparse matrix A is normally stored in a compressed sparse row (CSR) format.

In a load of the dense vector x in this inner product, a discrete access for every third element is made, for picking up elements corresponding to 26 or 27 non-zero elements in the rows in the sparse matrix A. Such indirect and discontinuous load/store via an address list is called gathering/scattering.

Japanese National Publication of International Patent Application No. 2019-521445, U.S. Pat. No. 10,592,468, U.S. Patent Publication No. 2020/0058133 are disclosed as related art.

### SUMMARY

According to an aspect of the embodiments, an arithmetic processing device including one or more lanes configured to execute at most a single element operation of an instruction for each cycle; and an element operation issuing processor configured to issue the element operations to the one or more lanes, wherein while each lane is separated into a plurality of sections by a buffer that has a plurality of entries and while the one or more sections that are not able to continue processing of the element operations stop the processing, another section stores an element operation that proceeds to each downstream section in an immediately subsequent buffer and continues processing, and at a horizontal addition processing, a lane in which addition results are finally aggregated is set to be variable, and a target lane that wait for synchronization is set to be a lane adjacent to own lane.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a program that represents sparse matrix calculation;

FIG. 2 is a diagram for explaining continuous loading and gathering of an SIMD;

FIG. 3 is a diagram for explaining gathering in a multi-banked primary data cache of the SIMD;

FIG. 4 is a block diagram schematically illustrating an Out-of-Step backend pipeline according to an embodiment;

FIG. 5 is a diagram for explaining arithmetic element processing in an In-Step pipeline and the Out-of-Step backend pipeline;

FIG. 6 is a diagram for explaining the arithmetic element processing in the In-Step pipeline and the Out-of-Step backend pipeline;

FIG. 7 is a diagram for explaining the arithmetic element processing in the In-Step pipeline and the Out-of-Step backend pipeline;

FIG. 8 is a diagram for explaining the arithmetic element processing in the In-Step pipeline and the Out-of-Step backend pipeline;

FIG. 9 is a diagram for explaining the arithmetic element processing in the In-Step pipeline and the Out-of-Step backend pipeline;

FIG. 10 is a diagram for explaining stalls in the In-Step pipeline and the Out-of-Step backend pipeline;

FIG. 11 is a block diagram for explaining arithmetic processing of horizontal addition;

FIG. 12 is a diagram for explaining arithmetic processing of horizontal addition for arithmetic elements in the In-Step pipeline and the Out-of-Step back end pipeline;

FIG. 13 is a diagram illustrating an arithmetic circuit in the Out-of-Step backend pipeline according to the embodiment;

FIG. 14 is a flowchart for explaining horizontal addition processing by a secondary scheduler illustrated in FIG. 13;

FIG. 15 is a diagram illustrating topologies of addition processing according to a related example and the embodiment;

FIG. 16 is a diagram illustrating a bypass between LGs in the arithmetic circuit illustrated in FIG. 13;

FIG. 17 is a diagram illustrating topologies of the addition processing and shuffling processing according to the embodiment;

FIG. 18 is a block diagram illustrating a determination circuit in the secondary scheduler illustrated in FIG. 13;

FIG. 19 is a flowchart for explaining buffer clogging degree determination processing by the determination circuit illustrated in FIG. 18;

FIG. 20 is a flowchart for explaining selector control processing by the secondary scheduler illustrated in FIG. 13;

FIG. 21 is a block diagram illustrating a data connection line between lanes in the arithmetic circuit illustrated in FIG. 13;

FIG. 22 is a block diagram schematically illustrating a hardware configuration example of an arithmetic processing device according to the embodiment;

FIG. 23 is a diagram for comparing the arithmetic element processing in the In-Step pipeline and the Out-of-Step backend pipeline; and

FIG. 24 is a diagram for comparing the arithmetic element processing in the In-Step pipeline and the Out-of-Step backend pipeline.

### DESCRIPTION OF EMBODIMENTS

Because efficiency of gather/scatter processing by typical processor cores is low, there is a possibility that a processing speed is lowered due to occurrence of the gather/scatter processing.

In one aspect, an object is to suppress decrease in a processing speed of pipeline processing in which horizontal addition occurs.

### [A] Embodiment

Hereinafter, an embodiment will be described with reference to the drawings. However, note that the embodiment to be described below is merely an example, and there is no intention to exclude applications of various modifications and techniques not explicitly described in the embodiment. For example, the present embodiment may be variously modified and carried out without departing from the spirit thereof. Furthermore, each drawing is not intended to include only components illustrated in the drawing, and may include another function and the like.

Hereinafter, in the drawings, the same reference signs each indicate a similar part, and thus the description of the similar part will be omitted.

In recent years, in order to prevent infectious or the like, simulations of droplets exhaled from human oral cavities have been actively performed. In such simulations, air flow calculations (in other words, fluid calculations) and droplet movement calculations are performed. Sparse matrix calculation is dominant in the fluid calculation. A sparse matrix is a matrix in which most of elements are zero. A main sparse matrix calculation is sparse matrix-vector multiplication (SpMV).

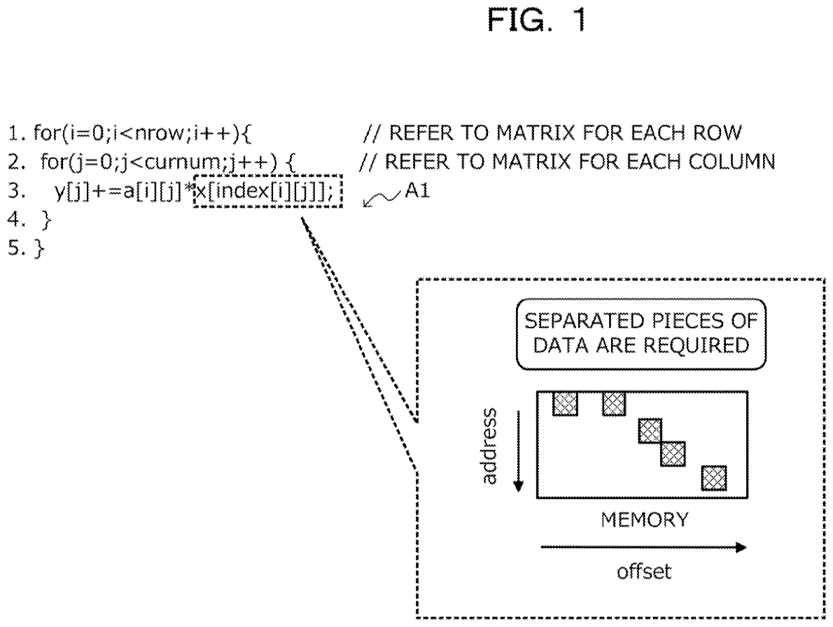

FIG. 1 is a diagram illustrating a program that represents sparse matrix calculation.

The sparse matrix calculation using the SpMV is often used in graph calculation or the like. As indicated by a reference A1, in a third line of a program, separated pieces of data for a memory offset (offset) and an address (address) are required.

High peak performance of high performance processor cores in recent years may be realized by a single instruction/multiple data-stream (SIMD) unit. The SIMD packs v elements into a single register and simultaneously executes v operations in response to one instruction. As a result, even if a control unit remains as it is, peak performance can be multiplied by v. For example, in a case where a 512b SIMD is used as 64b (double floating-point precision number)×8, arithmetic performance is multiplied eightfold.

In load/store of the SIMD, in a case where target elements are continuous on a memory, continuous v elements can be accessed once. Such continuous load/store performance is multiplied by v and can achieve a SIMD effect the same as the operation.

On the other hand, in a case where the target elements of load/store of the SIMD are not continuous on the memory, the SIMD effect cannot be achieved. Indirect and discontinuous load/store via an address list is referred to as gathering/scattering. In gathering/scattering, even if the continuous v elements are accessed, all the v elements rarely can be used, and performance of gathering/scattering is much lower than v times.

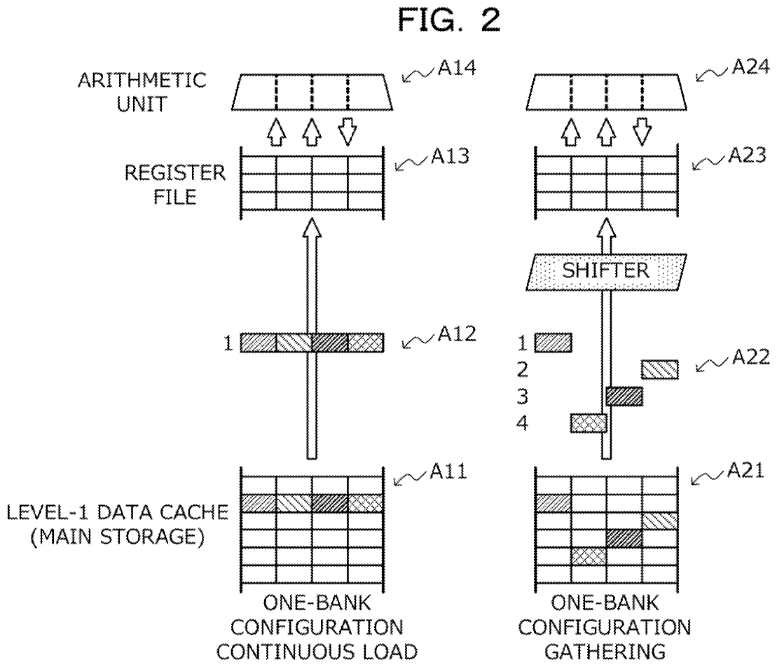

FIG. 2 is a diagram for explaining the continuous loading and gathering of the SIMD.

In continuous load processing having a one-bank configuration indicated by references A11 to A14, as indicated by the reference A11, four elements stored in continuous addresses on a primary (LEVEL-1) data cache are read. Therefore, as indicated by the reference A12, a block including the four elements is read by one access unit [1]. Then, the four elements are written into a register file that is a SIMD width of the four elements as indicated by the reference A13, and the four elements written into the register file are used by an execution unit as indicated by the reference A14.

In gather processing having a one-bank configuration indicated by references A21 to A24, as indicated by the reference A21, elements stored in discontinuous addresses on the primary data cache are read. In this case, it is not possible to read the four elements once, and it is needed to read four blocks including the four elements by access units [1] to [4] as indicated by the reference A22. Then, the four elements are written into the register file via a shifter as indicated by the reference A23, and the four elements written into the register file are used by the execution unit as indicated by the reference A24.

A multiport memory that can access v elements at any address increases an area and energy in proportion to v². Therefore, in order to multiply gathering/scattering performance by v as well as the arithmetic performance, it is assumed to perform multi-banking as pseudo multi-porting.

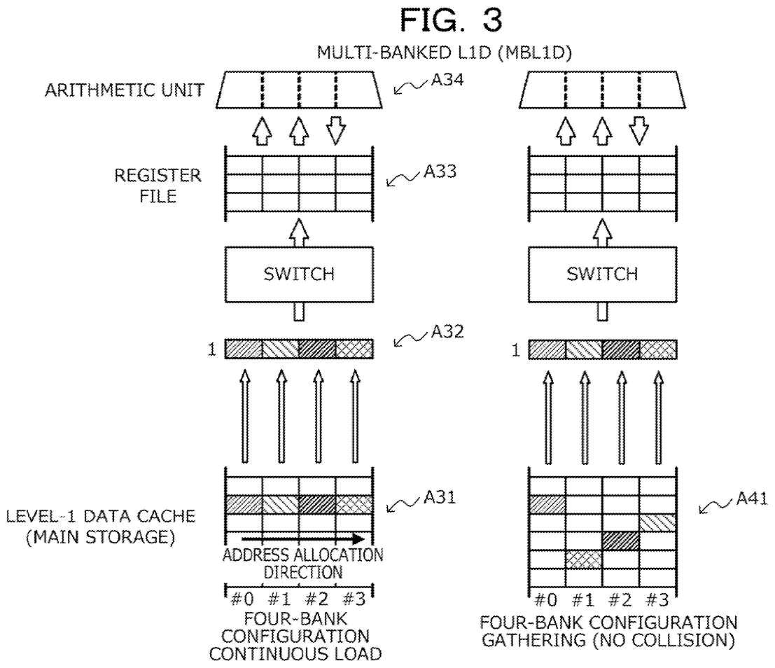

FIG. 3 is a diagram for explaining gathering in a multi-banked primary data cache of the SIMD.

In the gather processing with a four-bank configuration indicated by references A31 to A34, the primary (LEVEL-1) data cache is divided into four banks #0 to #3 in order in an address allocation direction. As indicated by the reference A32, four elements can be read once by one access unit [1]. Then, as indicated by the reference A33, the four elements are written into the register file via a switch, not a shifter. Thereafter, as indicated by the reference A34, the four elements written into the register file are used by the arithmetic unit.

At the reference A41, the primary data cache is discontinuously divided into the four banks #0 to #3. In such a case, as long as the plurality of elements does not collide with the same bank, up to four elements can be concurrently read in parallel from each of the banks #0 to #3.

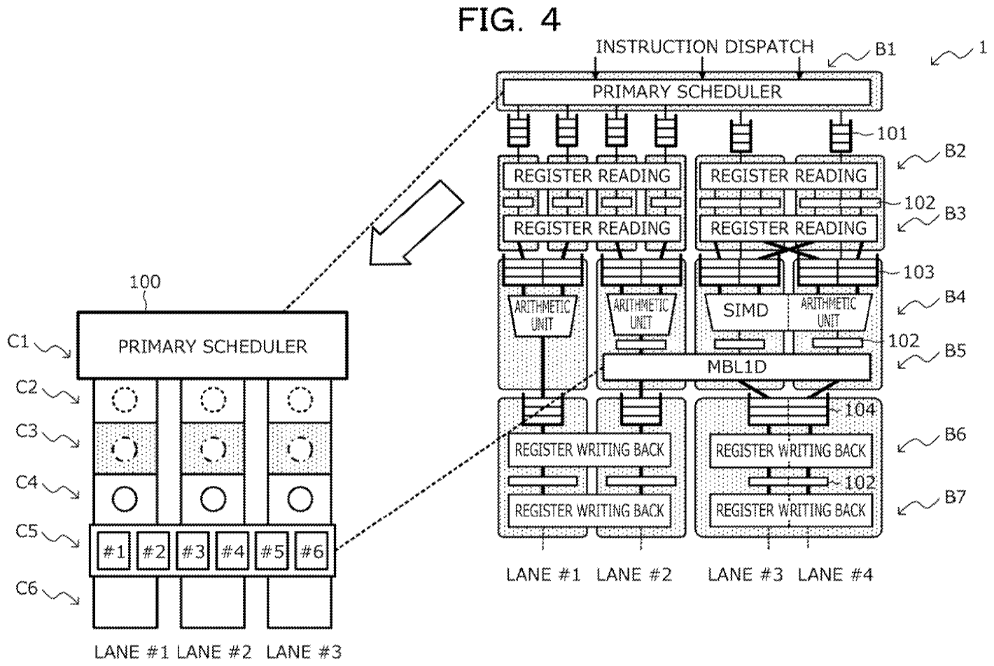

FIG. 4 is a block diagram schematically illustrating an Out-of-Step backend pipeline 1 according to an embodiment.

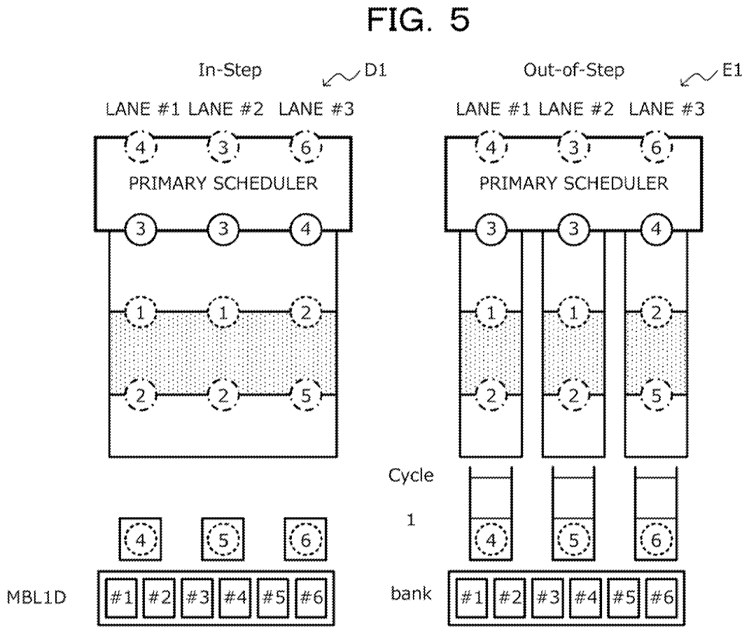

Out-of-Step is a negation/complementary set of In-Step to be described later with reference to FIGS. 5 to 10 or the like. In the Out-of-Step backend pipeline 1, an element operation does not keep a spatial and temporal position relationship when being issued.

Some or all of one or more lanes may correspond to an operation of a SIMD instruction. In the example illustrated in FIG. 4, lanes #1 and #2 have a scalar configuration, and lanes #3 and #4 have a SIMD configuration. As indicated by a reference B1, element operations generated from different microoperations (μOP) are issued from a primary scheduler 100 to the respective lanes #1 and #2, and two element operations generated from one μOP are issued to the lanes #3 and #4. Each issued element operation is stored in a buffer 101.

The instruction is defined by an instruction set architecture (ISA), cached from a binary code on a main storage device to an instruction cache, and is a subject to be fetched by a machine.

The μOP is a unit obtained by decomposing a complicated instruction in x86, SVE, or the like into a plurality of simple processes. The μOP is converted from the instruction fetched in the core and is a subject to be scheduled. A SIMD μOP is generated from the SIMD instruction. Note that, it can be understood that, in a core that does not use the μOP, one μOP equivalent to one instruction is generated for one instruction.

As indicated by references B2 and B3, register reading is performed in the lanes #1 to #4 over two stages. A register reading result is stored in a buffer 103 immediately before an arithmetic unit.

As indicated by a reference B4, element operations are performed by respectively different arithmetic units in the lanes #1 and #2, and the element operation is performed by a common SIMD arithmetic unit in the lanes #3 and #4. As indicated by a reference B5, the element operation is performed with an MBL1D (Multi-Bank Level 1 Cache) in the lanes #2 to #4. An element operation execution result is stored in a buffer 104 immediately before register write back.

Then, as indicated by references B6 and B7, register write-back is performed in the lanes #1 to #4 over two stages.

In the Out-of-Step backend pipeline 1, in a case where it is assumed that an event such that processing of the element operation cannot be continued does not occur, the primary scheduler 100 may issue an interdependent element operation at a time when data can be transferred by the register file or the bypass. On the other hand, each lane of the Out-of-Step backend pipeline 1 arbitrarily changes a positional relationship between the element operations at the time of the issuance by the primary scheduler 100 and correctly executes processing.

The buffers 101, 103, and 104 at stage boundaries of the Out-of-Step backend pipeline 1 in FIG. 4 are not single-entry pipeline registers, but are buffers including a plurality of entries.

All the lanes are separated into a plurality of sections by the buffers 101, 103, and 104.

In a case where an element operation that cannot continue processing due to cache miss, bank collision, or the like is included in the section, the section stops processing. This is called a section stall. On the other hand, an upstream section across the buffer can continue processing. If there is an element operation that ends the processing of the upstream section and proceeds to a section being stalled, it is sufficient that the element operation be stored in the buffer therebetween. In the Out-of-Step backend pipeline 1, each section can independently perform a stall. A pipeline register 102 in the Out-of-Step backend pipeline 1 independently operates for each section, not across all the lanes.

Separation into sections is not limited to lane boundaries. For example, because reading from the buffer 101 and writing into the buffer 103 can be performed for each of two source operands, the number of register reading sections for each lane is two, and it is allowed that two source operands do not perform reading at the same time. On the other hand, reading of the buffer 104 is performed in the lanes #3 and #4 at the same time, and a register reading section of the lanes #3 and #4 straddles the lanes #3 and #4.

The buffers 101, 103, and 104 in the Out-of-Step backend pipeline 1 may be first in-first out (FIFO) buffers, and in this case, overtaking of the element operation does not occur in the lane.

For example, the Out-of-Step backend pipeline 1 includes one or more lanes that execute at most a single element operation of the instruction for each cycle (each clock cycle, for example) and the primary scheduler 100 (in other words, element operation issuing unit) that issues the element operations to the one or more lanes. The whole is separated into a plurality of sections with the buffers 101, 103, and 104. One or more sections that cannot continue the processing of the element operation stop the processing. On the other hand, other sections store the element operation that proceeds to each of downstream sections in an immediately subsequent buffer and continue the processing of the element operation.

Either one of both of the register files and the primary data cache may have a multi-bank configuration, and a bank collision in the multi-bank configuration may be one of factors that make it impossible to continue the processing of the element operation.

In the Out-of-Step backend pipeline 1, because a result of scheduling by the primary scheduler 100 is only delayed, it is possible to minimize hardware costs.

In FIG. 4, as indicated by a reference C1, the primary scheduler 100 schedules the element operations. As indicated by a reference C2, element operations are issued (issue) to the three lanes #1 to #3 as entering a backend pipeline. As indicated by a reference C3, register reading is performed for the element operation. As indicated by a reference C4, the element operation is executed. Note that instructions that are issued at the same time are executed between each of the lanes #1 to #3 at the same time as LD instructions. As indicated by a reference C5, a multi-bank configuration including six banks #1 to #6 (in other words, MBL1D) executes the element operations, and banks to be accessed are randomly determined. Then, as indicated by a reference C6, register write-back is performed for the element operation.

FIGS. 5 to 9 are diagrams for explaining arithmetic element processing in the In-Step pipeline and the Out-of-Step backend pipeline 1. In FIGS. 5 to 9, a state of a pipeline in each of Cycles 1 to 5 is illustrated. In FIGS. 5 to 9, a number in the LD instruction in the pipeline represents a bank number to be accessed that is randomly specified.

In the Cycle 1 illustrated in FIG. 5, in the In-Step pipeline indicated by a reference D1, LD instructions 4 to 6 are respectively stored in buffers of the lanes #1 to #3. Furthermore, in the Out-of-Step backend pipeline 1 indicated by a reference E1, LD instructions 4 to 6 are respectively stored in the buffers of the lanes #1 to #3.

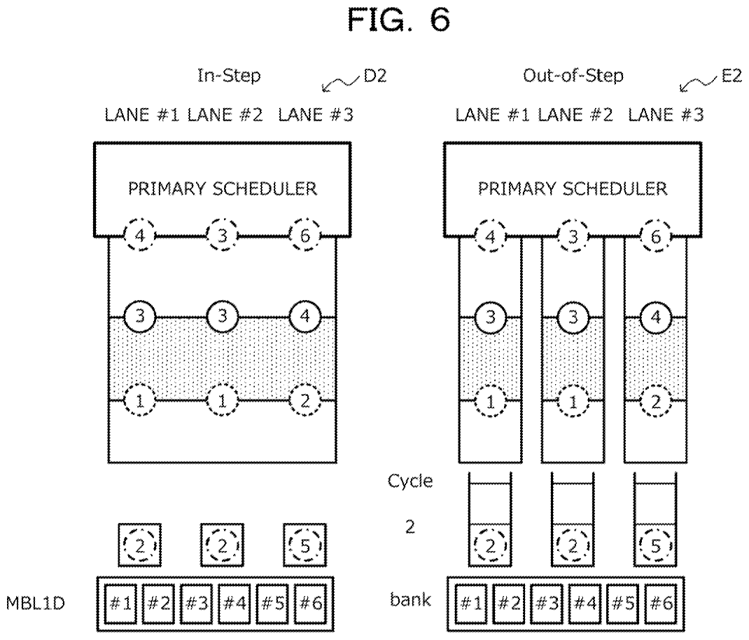

In the Cycle 2 illustrated in FIG. 6, in the In-Step pipeline indicated by a reference D2, LD instructions 2, 2, and 5 are respectively stored in buffers of the lanes #1 to #3. Furthermore, in the Out-of-Step backend pipeline 1 indicated by a reference E2, LD instructions 2, 2, and 5 are respectively stored in the buffers of the lanes #1 to #3.

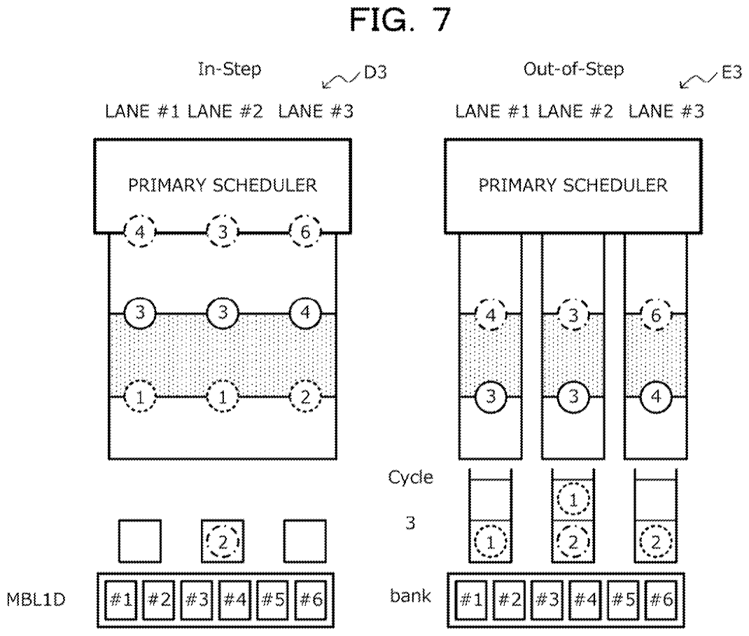

In the Cycle 3 illustrated in FIG. 7, in the In-Step pipeline indicated by a reference D3, the LD instruction 2 is stored in the buffer of the lane #2 in which accesses to a bank #2 are overlapped (collided) in the Cycle 2. Furthermore, in the Out-of-Step backend pipeline 1 indicated by a reference E3, the LD instruction 1 is stored in the buffer of the lane #1, the LD instructions 2 and 1 are stored in input order in the buffer of the lane #2 in which the accesses to the bank #2 are overlapped in the Cycle 2, and the LD instruction 2 is stored in the buffer of the lane #3.

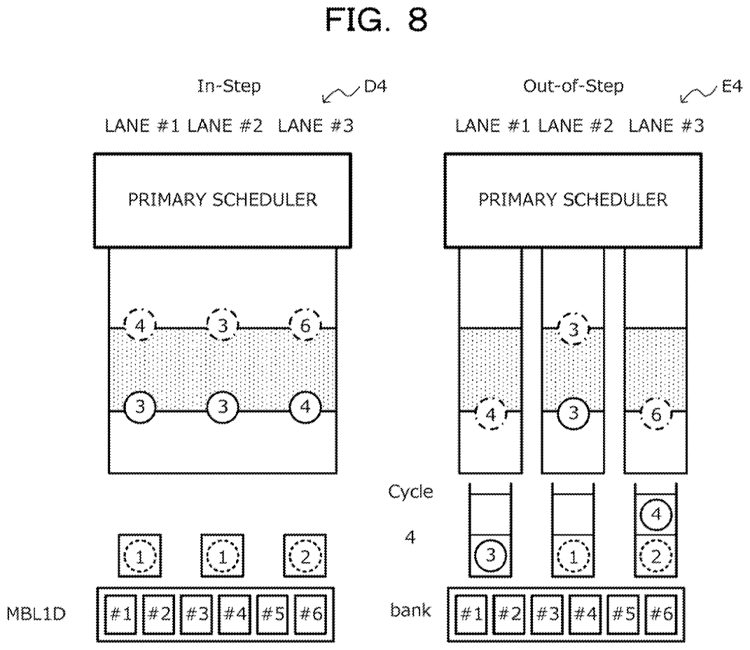

In the Cycle 4 illustrated in FIG. 8, in the In-Step pipeline indicated by a reference D4, the LD instructions 1, 1, and 2 are respectively stored in the buffers of the lanes #1 to #3. Furthermore, in the Out-of-Step backend pipeline 1 indicated by a reference E4, the LD instruction 3 is stored in the buffer of the lane #1, the LD instruction 1 is stored in the buffer of the lane #2, and the LD instructions 2 and 4 are stored in input order in the buffer of the lane #3 in which the access to the bank #2 is overlapped in the Cycle 3.

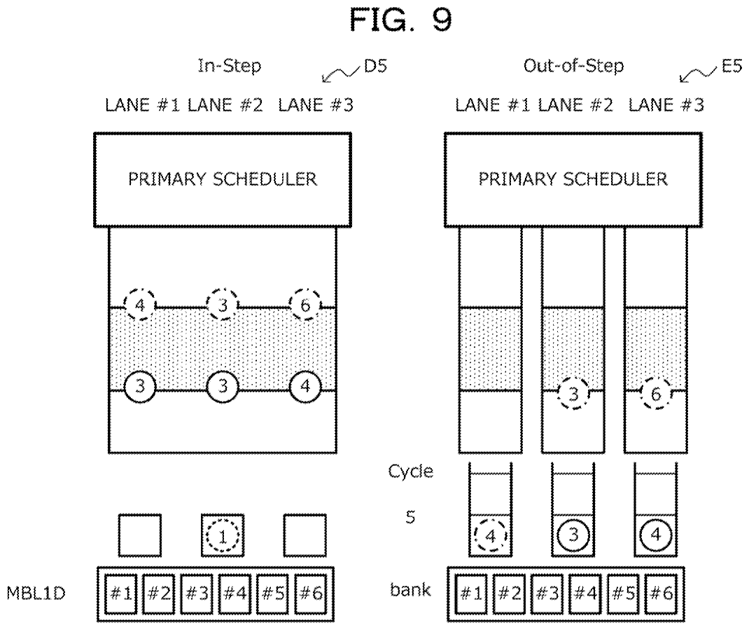

In the Cycle 5 illustrated in FIG. 9, in the In-Step pipeline indicated by a reference D5, the LD instruction 1 is stored in the buffer of the lane #2 in which the accesses to the bank #1 are overlapped in the Cycle 4. Furthermore, in the Out-of-Step backend pipeline 1 indicated by a reference E5, the LD instruction 4 is stored in the buffer of the lane #1, the LD instruction 3 is stored in the buffer of the lane #2, and the LD instruction 4 is stored in the buffer of the lane #3.

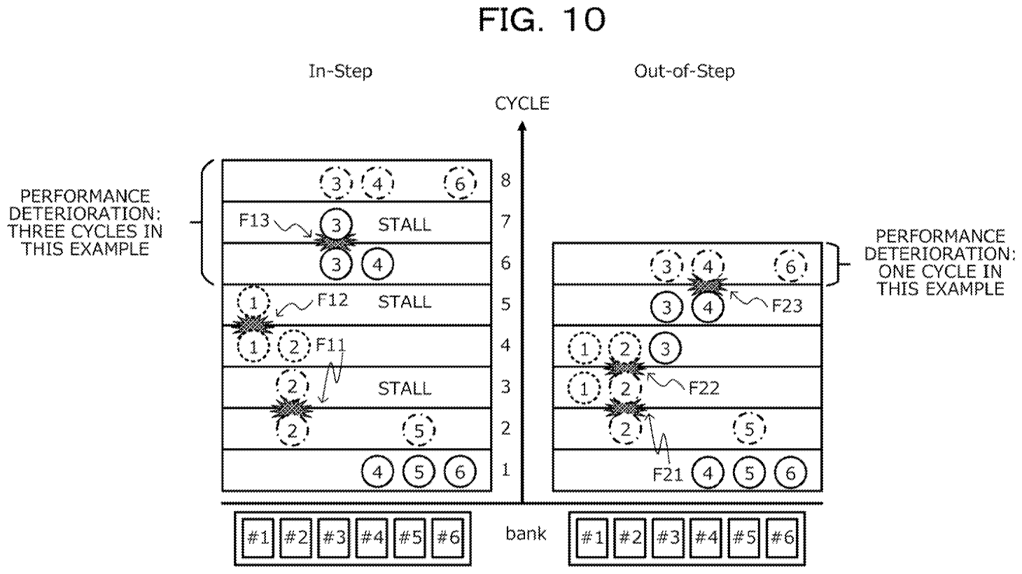

FIG. 10 is a diagram for explaining the stalls in the In-Step pipeline and the Out-of-Step backend pipeline 1. At each time, it is illustrated that the issued element operation is located in which of the banks #1 to #6.

As indicated by references F11 to F13, in the In-Step pipeline, eight cycles are consumed after three stalls occur and before all the element operations are completed. In this example, for an LD instruction, which is ideal for five cycles, performance deterioration of three cycles occurs.

On the other hand, as indicated by references F21 to F23, in the Out-of-Step backend pipeline 1, although three stalls occur as in the In-Step pipeline, six cycles are consumed before all the element operations are completed. In this example, for an LD instruction, which is ideal for five cycles, performance deterioration of only one cycle occurs.

The number of actual accesses (for example, SIMD width×2) and the number of banks are larger, and when considering multiple collisions, a difference between the performance deteriorations further increases.

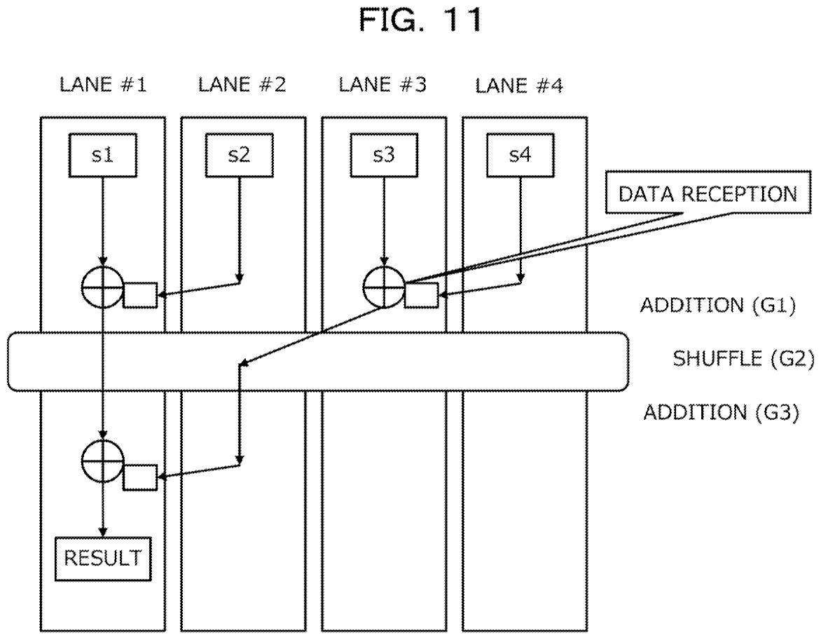

FIG. 11 is a block diagram for explaining arithmetic processing of horizontal addition.

A normal SIMD instruction performs the same operation for a plurality of elements in parallel as follows.

Z[0]=X[0]+Y[0];

Z[1]=X[1]+Y[1];

Z[2]=X[2]+Y[2];

Z[3]=X[3]+Y[3];

Furthermore, there is an operation for performing the following horizontal addition.

Z[0]=X[0]+X[1]+X[2]+X[3]

The horizontal addition is divided into a plurality of operations as illustrated in FIG. 11. In the example illustrated in FIG. 11, as indicated by a reference G1, data s1 in the lane #1 and data s2 received from the lane #2 are added in the lane #1, and data s3 in the lane #3 and data s4 received from the lane #4 are added in the lane #3. Then, the addition results of the lanes #1 and #3 are shuffled as indicated by a reference G2, and the addition result of the lane #1 and the addition result received from the lane #3 are added in the lane #1 and an operation result is output as indicated by a reference G3.

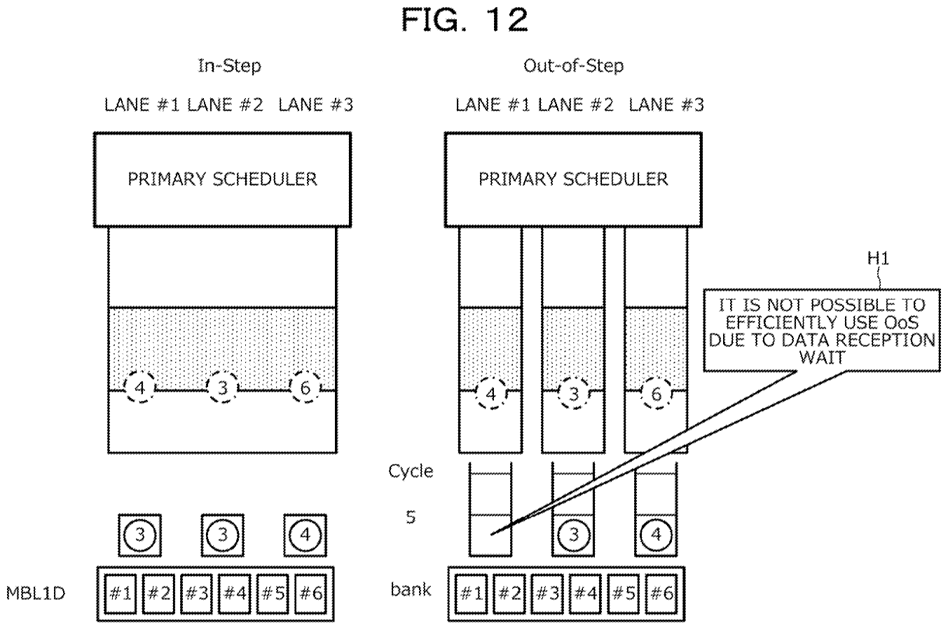

FIG. 12 is a diagram for explaining arithmetic processing of horizontal addition for arithmetic elements in the In-Step pipeline and the Out-of-Step backend pipeline 1.

In the Cycle 4 illustrated in FIG. 8, it is assumed that the In-Step pipeline indicated by the reference D4 and the LD instructions 4, 3, and 6 indicated by alternate long and short dash line circles in the Out-of-Step backend pipeline 1 indicated by a reference E4 be horizontal addition. In this case, as indicated by a reference H1 in FIG. 12, data reception wait occurs in the buffer of the lane #1 in the Out-of-Step backend pipeline 1, and it is not possible to effectively use Out-of-Step (OoS).

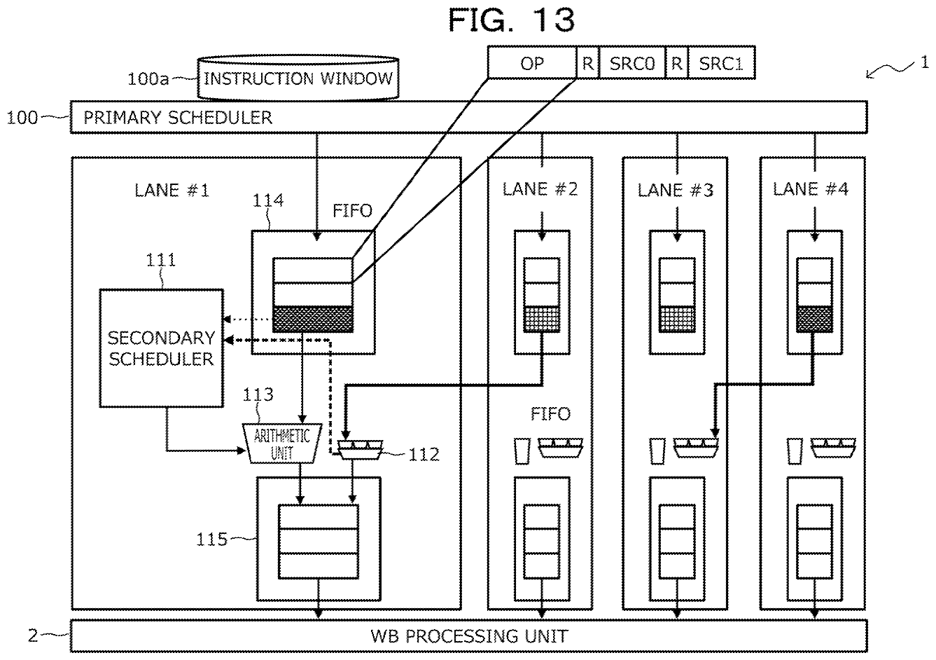

FIG. 13 is a diagram illustrating an arithmetic circuit in the Out-of-Step backend pipeline 1 according to the embodiment.

The primary scheduler 100 outputs arithmetic elements related to the instructions input from an operator via an instruction window 100a to each of the lanes #1 to #4. Output from each of the lanes #1 to #4 is input to a WB processing unit 2 that executes write-back processing.

The lane #1 may include a secondary scheduler 111, a selector 112, an arithmetic unit 113, and buffers 114 and 115. Note that, although not illustrated in FIG. 13, the lanes #2 to #4 may include the secondary scheduler 111, the selector 112, the arithmetic unit 113, and the buffers 114 and 115.

The buffer 114 is a FIFO buffer, and each register stores an arithmetic element configured in a format including an operand (OP), a reserve (R), a source (SRC0), a reserve (R), and a source (SRC1).

The secondary scheduler 111 receives the arithmetic element of the buffer 114 of the own lane #1 and an arithmetic element output from an adjacent lane via the selector 112 and outputs the received arithmetic elements to the arithmetic unit 113. Then, the outputs from the arithmetic unit 113 and the selector 112 are stored in the buffer 115 in the FIFO format.

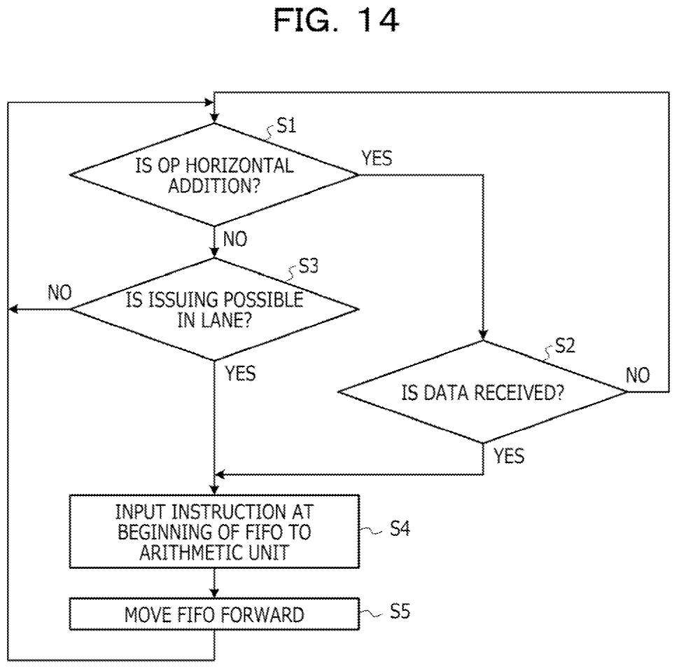

The horizontal addition processing by the secondary scheduler 111 illustrated in FIG. 13 will be described with reference to the flowchart illustrated in FIG. 14.

The secondary scheduler 111 determines whether or not an instruction (OP) is horizontal addition (step S1).

In a case where the OP is horizontal addition (refer to YES route in step S1), the secondary scheduler 111 determines whether or not data is received from another lane (step S2).

In a case where no data is received (refer to NO route in step S2), the processing returns to step S1.

On the other hand, in a case where data is received (refer to YES route in step S2), the processing proceeds to step S4.

In a case where the OP is not horizontal addition in step S1 (refer to NO route in step S1), the secondary scheduler 111 determines whether or not OP can be issued in the lane (step S3).

In a case where it is not possible to issue the OP in the lane (refer to NO route in step S3), the processing returns to step S1.

On the other hand, in a case where the OP can be issued in the lane (refer to YES route in step S3), the secondary scheduler 111 inputs an instruction at the beginning of the FIFO into the arithmetic unit 113 (step S4).

The secondary scheduler 111 moves the FIFO forward (step S5).

Then, the processing returns to step S1.

The horizontal addition instruction needs to wait for data reception from the adjacent lane. Therefore, an asynchronous operation for each lane that is an advantage of the OoS is limited, and there is a possibility that the advantage of the OoS is reduced.

Therefore, in the present embodiment, an addition pair of the horizontal addition is dynamically changed. For example, a lane that has a final result of horizontal addition is made variable, and shuffle is added at the end so as to move the addition result between arbitrary lanes. Although there is often a pattern in which the final result is moved to the left end, a lane having the final result may be selected depending on a clogging degree of the FIFO. Furthermore, connection of data lines between the lanes for shuffle may be torus-shaped.

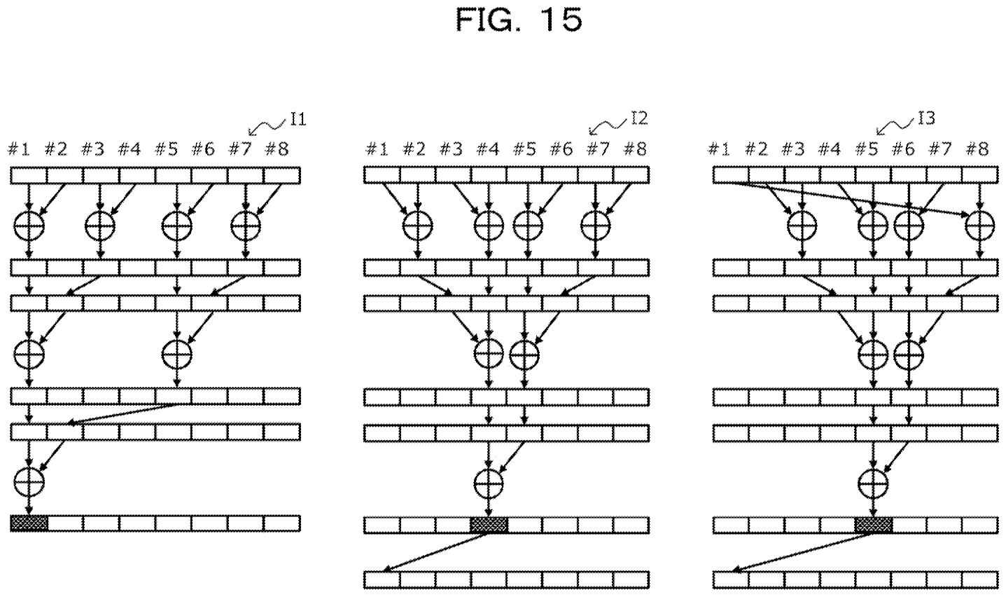

FIG. 15 is a diagram illustrating topologies of addition processing according to a related example and the embodiment.

In a topology in the related example indicated by a reference I1, outputs from lanes #1 and #2 are added in the lane #1, outputs from lanes #3 and #4 are added in the lane #3, outputs from lanes #5 and #6 are added in the lane #5, and outputs from lanes #7 and #8 are added in the lane #7. Thereafter, operation results of the lanes #1 and #3 are added in the lane #1, and operation results of the lanes #5 and #7 are added in the lane #5. Then, outputs from the lanes #1 and #5 are added in the lane #1 and output.

In a topology in the embodiment indicated by a reference 12, outputs from the lanes #1 and #2 are added in the lane #2, outputs from the lanes #3 and #4 are added in the lane #4, outputs from the lanes #5 and #6 are added in the lane #5, and outputs from the lanes #7 and #8 are added in the lane #7. Thereafter, operation results of the lanes #2 and #4 are added in the lane #4, and operation results of the lanes #5 and #7 are added in the lane #5. Then, the outputs from the lanes #4 and #5 are added in the lane #4, and shuffled and output to the lane #1.

In a topology in the embodiment indicated by a reference 13, outputs from the lanes #2 and #3 are added in the lane #3, outputs from the lanes #4 and #5 are added in the lane #5, outputs from the lanes #6 and #7 are added in the lane #6, and outputs from the lanes #1 and #8 are added in the lane #8. Thereafter, operation results of the lanes #3 and #5 are added in the lane #5, and operation results of the lanes #6 and #8 are added in the lane #6. Then, the outputs from the lanes #5 and #6 are added in the lane #5, and shuffled and output to the lane #1.

In this way, in the Out-of-Step backend pipeline 1 according to the embodiment, the lane having the final result of the horizontal addition is variable.

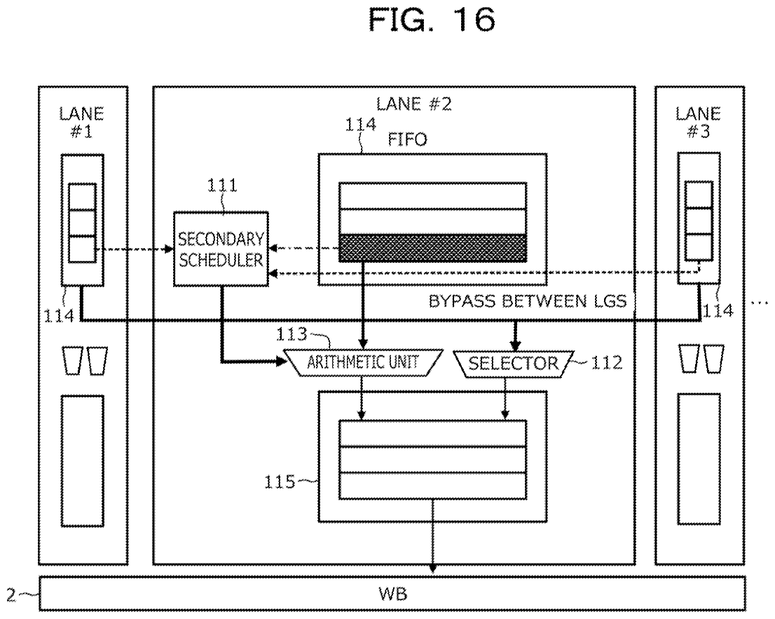

FIG. 16 is a diagram illustrating a bypass between LGs (Lane Groups) in the arithmetic circuit illustrated in FIG. 13.

In the example illustrated in FIG. 16, the selector 112 in the lane #2 is connected to the buffers 114 in the adjacent lanes #1 and #3 via the bypass between the LGs. In this way, lanes to be synchronized are set to lanes having lane numbers that are ±1 of their own lane, not all the lanes.

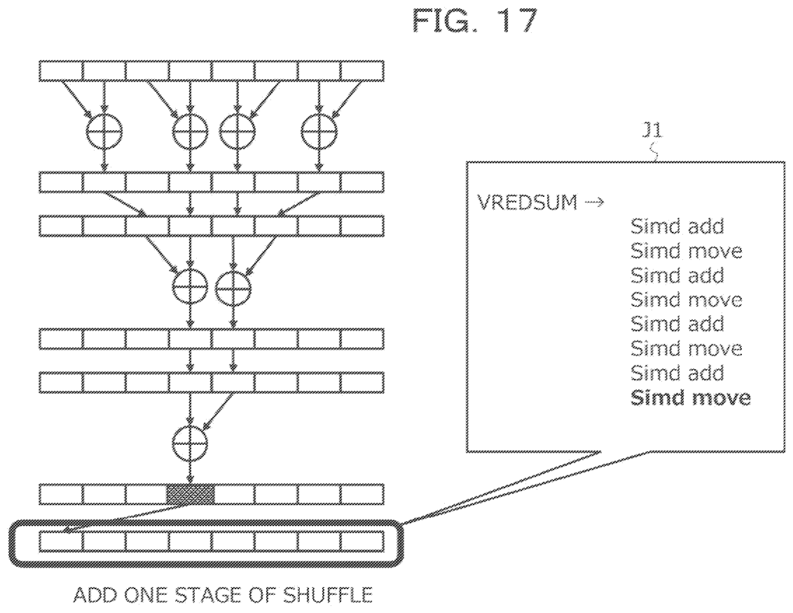

FIG. 17 is a diagram illustrating topologies of the addition processing and shuffling processing according to the embodiment.

As indicated by a reference J1, one stage of the shuffling processing is added at the end of the topology. In an instruction VREDSUM, SIMD move is add after repetition of SIMD add and SIMD move.

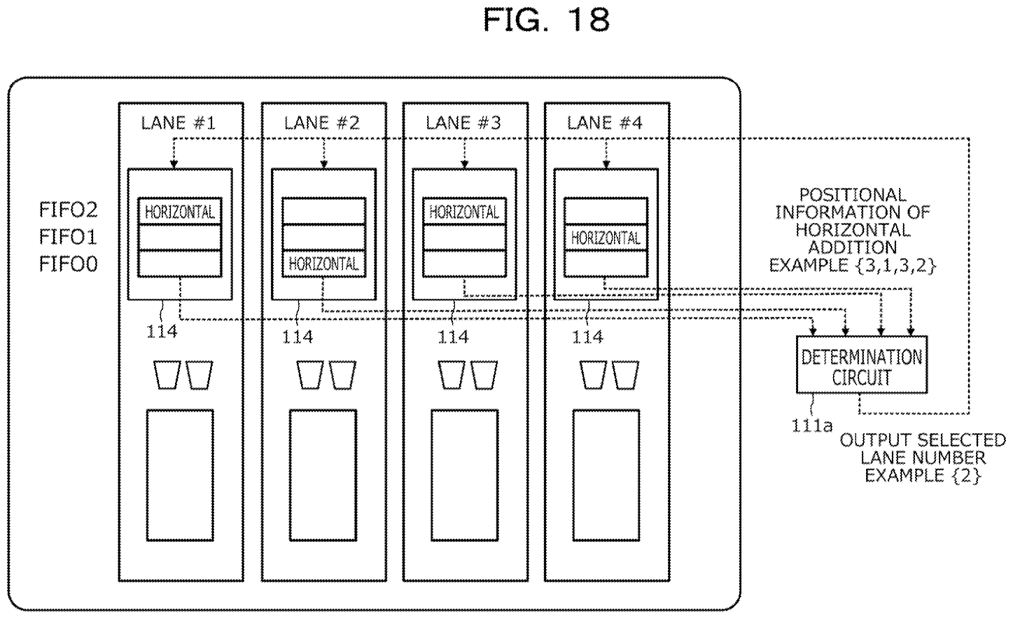

FIG. 18 is a block diagram illustrating a determination circuit 111a in the secondary scheduler 111 illustrated in FIG. 13.

The secondary scheduler 111 illustrated in FIG. 13 may have a function as the determination circuit 111a. The determination circuit 111a monitors all the lanes and returns a determination result regarding the clogging degree of the FIFO to all the lanes.

In the example illustrated in FIG. 18, in the buffer 114, horizontal addition is positioned in a FIFO 2 in the lane #1, horizontal addition is positioned in a FIFO 0 in the lane #2, horizontal addition is positioned in the FIFO 2 in the lane #3, and horizontal addition is positioned in a FIFO 1 in the lane #4.

To the determination circuit 111a, positional information of the horizontal addition in the buffers 114 of the respective lanes #1 to #4 is input. In the example illustrated in FIG. 18, {3, 1, 3, 2} is input as the positional information of the horizontal addition.

The determination circuit 111a outputs a selected lane number to each lane. In the example illustrated in FIG. 18, {2} is output as the selected lane number.

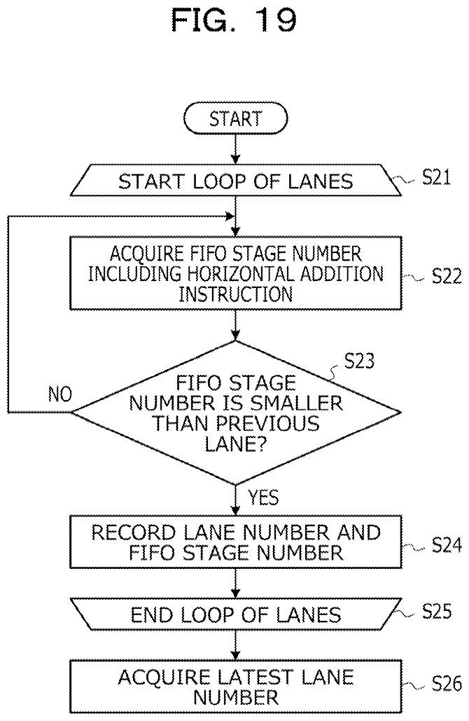

Buffer clogging degree determination processing by the determination circuit 111a illustrated in FIG. 18 will be described with reference to the flowchart (steps S21 to S26) illustrated in FIG. 19.

The determination circuit 111a starts a loop of the lanes (step S21) from the lane #1 to the lane #4.

The determination circuit 111a acquires a FIFO stage number which includes a horizontal addition instruction (step S22). Although not shown in FIG. 19, if no horizontal addition instruction is included in any of the FIFO stages, then, the loop commences to the next lane.

The determination circuit 111a determines whether or not the acquired FIFO stage number is smaller than the FIFO stage number including the horizontal addition instruction of the previous lane (step S23).

In a case where the acquired FIFO stage number is not smaller than that of the previous lane (refer to NO route in step S23), the processing returns to step S22, and repeats the steps for the next lane.

On the other hand, in a case where the acquired FIFO stage number is smaller than that of the previous lane (refer to YES route in step S23), the determination circuit 111a records the current lane number and the acquired FIFO stage number (step S24).

The determination circuit 111a ends the loop of the lanes (step S25) when all the lanes are checked.

The determination circuit 111a acquires a latest recorded lane number (step S26). Then, the buffer clogging degree determination processing ends.

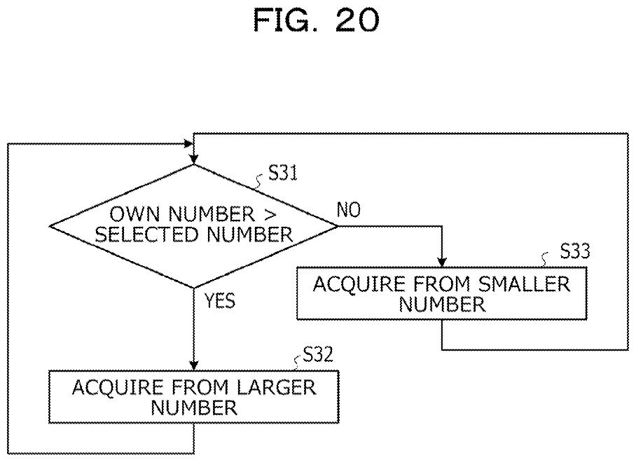

Next, processing for controlling the selector 112 by the secondary scheduler 111 illustrated in FIG. 13 will be described with reference to the flowchart (steps S31 to S33) illustrated in FIG. 20.

The secondary scheduler 111 determines whether or not its own lane number is larger than the lane number selected by the determination circuit 111a (step S31).

In a case where the own lane number is larger than the lane number selected by the determination circuit 111a (refer to YES route in step S31), the secondary scheduler 111 controls the selector 112 so as to acquire an arithmetic element from a lane having a number larger than the own lane number by one (step S32). Then, the processing returns to step S31.

On the other hand, in a case where the own lane number is equal to or less than the lane number selected by the determination circuit 111a (refer to NO route in step S31), the secondary scheduler 111 controls the selector 112 so as to acquire an arithmetic element from a lane having a number smaller than the own lane number by one (step S33). Then, the processing returns to step S31.

As indicated by the reference 12 in FIG. 15, the selector 112 is controlled so that a lane having a number equal to or less than a final lane acquires a source for addition from a lane with a smaller number and a lane having a number larger than the final lane acquires a source for addition from a lane with a larger number. Furthermore, as indicated by the reference 13 in FIG. 15, in a case where there is no smaller or larger number, the selector 112 is controlled so as to round once and acquire the source for addition from a lane with the smallest or largest number.

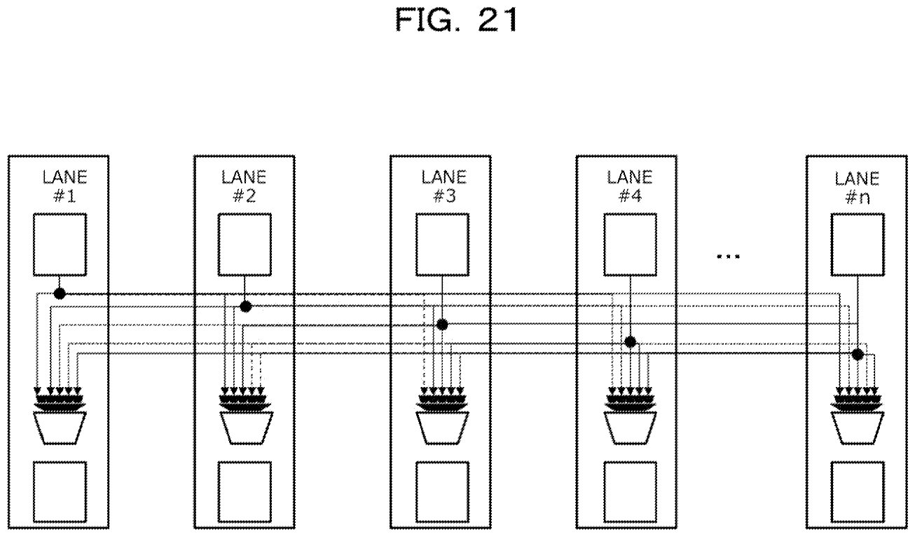

FIG. 21 is a block diagram illustrating a data connection line between lanes in the arithmetic circuit illustrated in FIG. 13.

Furthermore, connection of data lines between the lanes for shuffle may be torus-shaped.

As a SIMD length increases, there is a possibility that a circuit size of a crossbar increases, which lowers a clock frequency.

Therefore, a select logic including only adjacent lanes is used, and the lanes at the end are connected in a torus manner (connect lanes #n and #1 or the like). As a result, the number of signal lines used to synchronize each pair and collect arithmetic elements can be reduced.

In the example illustrated in FIG. 21, it is sufficient that dotted-line connection lines be omitted and only solid-line connection lines be remained.

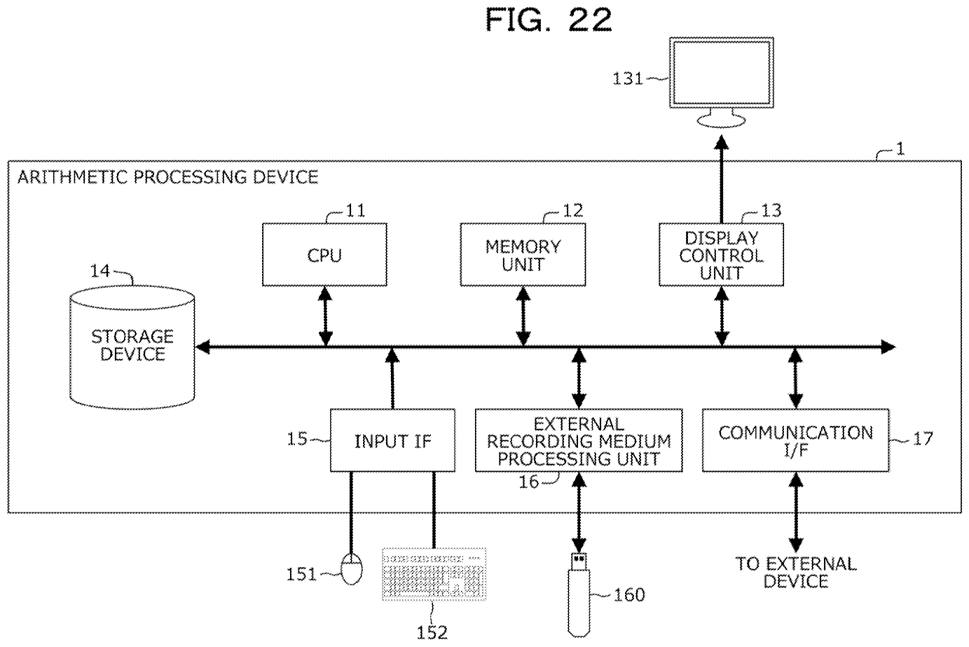

FIG. 22 is a block diagram schematically illustrating a hardware configuration example of the arithmetic processing device 10 according to the embodiment.

As illustrated in FIG. 22, the arithmetic processing device 1 is, for example, a high-performance computing (HPC) and includes a CPU 11, a memory unit 12, a display control unit 13, a storage device 14, an input interface (IF) 15, an external recording medium processing unit 16, and a communication IF 17.

The memory unit 12 is an example of a storage unit, which is, for example, a read only memory (ROM), a random access memory (RAM), or the like. Programs such as a basic input/output system (BIOS) may be written in the ROM of the memory unit 12. A software program of the memory unit 12 may be appropriately read and executed by the CPU 11. Furthermore, the RAM of the memory unit 12 may be used as a temporary recording memory or a working memory.

The display control unit 13 is connected to a display device 131, and controls the display device 131. The display device 131 is a liquid crystal display, an organic light-emitting diode (OLED) display, a cathode ray tube (CRT), an electronic paper display, or the like, and displays various types of information for an operator or the like. The display device 131 may be combined with an input device, and may be, for example, a touch panel.

The storage device 14 is a storage device having high input/output (IO) performance, and for example, a dynamic random access memory (DRAM), a solid state drive (SSD), a storage class memory (SCM), or a hard disk drive (HDD) may be used.

The input IF 15 may be connected to an input device such as a mouse 151 and a keyboard 152, and may control the input device such as the mouse 151 and the keyboard 152. The mouse 151 and the keyboard 152 are examples of the input devices, and an operator performs various types of input operations through these input devices.

The external recording medium processing unit 16 is configured in such a manner that a recording medium 160 may be attached thereto. The external recording medium processing unit 16 is configured to be capable of reading information recorded in the recording medium 160 in a state where the recording medium 160 is attached thereto. In the present example, the recording medium 160 is portable. For example, the recording medium 160 is a flexible disk, an optical disk, a magnetic disk, a magneto-optical disk, a semiconductor memory, or the like.

The communication IF 17 is an interface for enabling communication with an external device.

The CPU 11 is one example of a processor, and is a processing device that performs various controls and calculations. The CPU 11 implements various functions by executing an operating system (OS) or a program loaded in the memory unit 12. The CPU 11 functions as the Out-of-Step backend pipeline 1 illustrated in FIG. 13 or the like.

A device for controlling an operation of the entire arithmetic processing device 10 is not limited to the CPU 11, and may be, for example, any one of an MPU, a DSP, an ASIC, a PLD, or an FPGA. Furthermore, the device for controlling the operation of the entire arithmetic processing device 10 may be a combination of two or more of the CPU, MPU, DSP, ASIC, PLD, and FPGA. Note that the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field-programmable gate array.

### [B] Effects

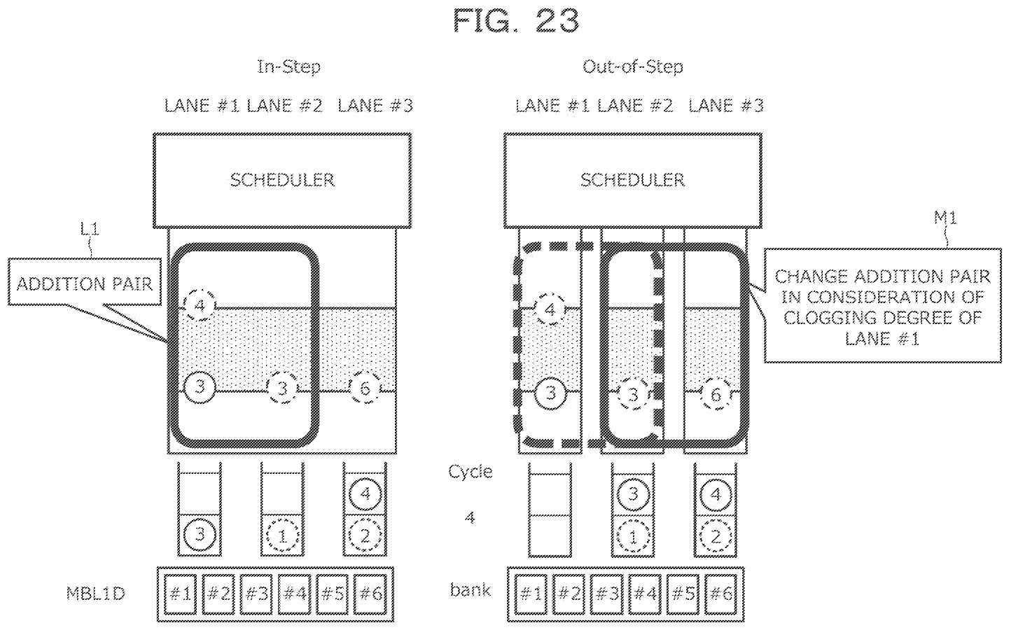

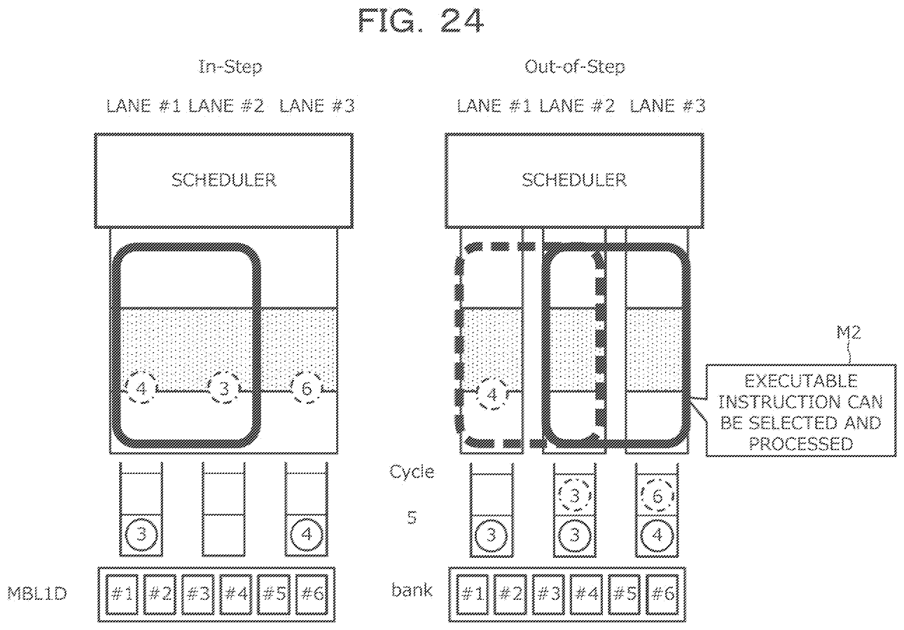

FIGS. 23 and 24 are diagrams for comparing the arithmetic element processing in the In-Step pipeline and the Out-of-Step backend pipeline 1.

In a Cycle 4 illustrated in FIG. 23, in the In-Step pipeline indicated by a reference L1, an addition pair is limited to the lanes #1 and #2. On the other hand, in the Out-of-Step backend pipeline 1 indicated by a reference M1, a clogging degree of a lane is determined, and an addition pair is set as the lanes #1 and #2 or lanes #2 and #3. In the example indicated by the reference M1, depending on the clogging degree of the lane #1, the pair of the lanes #2 and #3 may be selected.

In a Cycle 5 illustrated in FIG. 24, an executable instruction can be selected from the lanes #1 and #2 or lanes #2 and #3 and can be processed.

According to the arithmetic processing device 10 and an arithmetic processing method according to the embodiment described above, for example, the following effects can be obtained.

The Out-of-Step backend pipeline 1 includes the one or more lanes that execute at most a single element operation of the instruction for each cycle and the element operation issuing unit that issues the element operations to the one or more lanes. The entire Out-of-Step backend pipeline 1 is separated into a plurality of sections by the buffer that has a plurality of entries. The primary scheduler 100 stops the processing of one or more sections that cannot continue the processing of the element operation. On the other hand, other sections store the element operation that proceeds to each of downstream sections in an immediately subsequent buffer and continue processing. The secondary scheduler 111 sets the lane, in which the addition results are finally aggregated, to be variable at the time of the horizontal addition processing, and sets lanes adjacent to the own lane as target lanes that wait for synchronization together.

As a result, it is possible to provide an architecture that can suppress a decrease in a processing speed of pipeline processing in which horizontal addition occurs and improves a data transfer efficiency.

The range to be synchronized can be set for each addition pair, and a pairing method can be variable according to the clogging degree of the FIFO.

By modifying a synchronization selection logic, a circuit size increase and an operation frequency decrease due to an increase in the SIMD length can be prevented.

### [C] Others

The disclosed technology is not limited to the embodiment described above, and various modifications may be made without departing from the spirit of the present embodiment. Each of the configurations and processes according to the present embodiment may be selected as needed, or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device comprising:
one or more lanes configured to execute at most a single element operation of an instruction for each cycle; and
an element operation issuing processor configured to issue the element operations to the one or more lanes, wherein
each lane is separated into a plurality of sections by a buffer that has a plurality of entries and
the one or more sections that are not able to continue processing of the element operations stop the processing,
another section stores an element operation that proceeds to each downstream section in an immediately subsequent buffer and continues processing, and
at a horizontal addition processing, a lane in which addition results are aggregated is set to be variable, and a target lane that waits for synchronization is set to be a lane adjacent to its own lane.

2. The arithmetic processing device according to claim 1, wherein
the buffer is in a first in-first out (FIFO) method and does not cause overtaking of an element operation in each of the one or more lanes, and
the lane in which the addition results are aggregated is determined according to a buffer clogging degree.

3. The arithmetic processing device according to claim 2, wherein
the target lane that waits for the synchronization is selected from one of adjacent lanes according to the buffer clogging degree.

4. The arithmetic processing device according to claim 1, wherein
the one or more lanes are connected in a torus manner only for lanes adjacent each other.

5. The arithmetic processing device according to claim 1, wherein
some or all of the one or more lanes perform an element operation of a single instruction/multiple data stream (SIMD) instruction.

6. An arithmetic processing method performed by a computer comprising:
one or more lanes configured to execute at most a single element operation of an instruction for each cycle, where in each lane is separated into a plurality of sections by a buffer that has a plurality of entries; and
an element operation issuing processor configured to issue the element operations to the one or more lanes,
wherein the method including:
stopping the processing of the one or more sections that are not able to continue processing of the element operations,
continuing processing of another section and storing an element operation that proceeds to each downstream section in an immediately subsequent buffer, and
at a horizontal addition processing, setting a lane in which addition results are aggregated to be variable, and setting a target lane that waits for synchronization to be a lane adjacent to its own lane.

7. The arithmetic processing method according to claim 6, wherein
the buffer is in a first in-first out (FIFO) method and does not cause overtaking of an element operation in each of the one or more lanes, and
the lane in which the addition results are aggregated is determined according to a buffer clogging degree.

8. The arithmetic processing method according to claim 7, wherein
the target lane that waits for the synchronization is selected from one of adjacent lanes according to the buffer clogging degree.

9. The arithmetic processing method according to claim 6, wherein
the one or more lanes are connected in a torus manner only for lanes adjacent each other.

10. The arithmetic processing method according to claim 6, wherein
some or all of the one or more lanes perform an element operation of a single instruction/multiple data stream (SIMD) instruction.

11. A non-transitory computer-readable recording medium storing a program that causes a computer to execute a process, the process comprising:
starting a loop of lanes, each of the lanes correspond to an operation of a single instruction/multiple data stream (SIMD) instruction;
acquire a first-in-first-out (FIFO) stage number, the FIFO stage number includes a first horizontal addition instruction;
determining whether the FIFO stage number acquired is smaller than a second horizontal addition instruction in a previous lane;
recording a current lane number and the FIFO stage number;
ending the loop of lanes when all of the lanes have been checked; and
acquiring a latest recorded lane number.
